(19) United States
(12) Patent Application Publication
(10) Pub. No.: US 2003/0175543 A1
(43) Pub. Date: Sep. 18, 2003

(54) Hybrid metal matrix composites

(76) Inventor: Jason Sin Hin Lo, Nepean (CA)

Correspondence Address: SHAPIRO COHEN, P.O. BOX 3440, STATION D, OTTAWA, ON, K1P6P1, CA

(21) Appl. No.: 10/375,257

(22) Filed: Feb. 28, 2003

Related U.S. Application Data
(63) Continuation-in-part of application No. 09/660,177, filed on Sep. 12, 2000, now abandoned.

(51) Int. Cl. B32B 15/00

(52) U.S. Cl. 428/614; 428/293.1

(57) ABSTRACT

A hybrid composite reinforced metal matrix in which the metal is aluminum, aluminum alloy, or a magnesium alloy containing a relatively high percentage of aluminum. In addition to the reinforcement, which is typically alumina, the metal matrix also includes a hardening agent which is at least one intermetallic compound of aluminum with at least one second metal chosen from iron, nickel, titanium, zirconium, cobalt and niobium. The intermetallic compound(s) can be added as a powder to the metal matrix during formation of the composite, or can be created in the composite by adding the at least one second metal as a powder to the molten metal matrix during composite preparation. When the intermetallic compound(s) are created in the composite, during the addition step the second metal powder should be protected from oxidation. If the intermetallic compound is created in the composite, the composite when made initially can be readily machined and is self hardening through repeated heating cycles. The composite finds use in brake parts, such as brake rotors and brake drums as a replacement for the commonly used grey cast iron and exhibits adequate strength and compression properties up to a working temperature of at least about 450° C.

### RELATED APPLICATION

This application is a continuation-in-part of application No. 09/660,177 filed Sep. 12, 2000, now abandoned.

### BACKGROUND OF THE INVENTION

This invention is concerned with a hybrid aluminum matrix composite material of particular use in the fabrication of lightweight brake components. In this context, the term “aluminum” embraces both aluminum and its alloys. It also includes certain magnesium alloys which contain significant percentages of aluminium. More particularly, this invention is concerned with a hybrid aluminum matrix composite of particular use in the fabrication of brake parts, such as the rotating parts used in vehicle disc or drum brake systems, and in the fabrication of metal parts in which a combination of strength, improved wear resistance and acceptable resistance to elevated temperatures up to about 500° C. is required to a level not currently attainable with the known aluminium alloys.

The conventional disc brake, for example as used in the vehicle industry, consists of essentially three elements in combination: a rotor, at least two opposed brake pads usually supported by a metal backing, and a hydraulic cylinder system carried in a caliper which presses the opposed brake pads inwardly onto the surface of the rotor. The drum brake also contains essentially the same three parts, by means of which the brake pads are pressed outwardly to engage the inner face of the drum. For both types, the hydraulic system is constructed to urge the brake pads into frictional engagement with the rotor or brake drum when hydraulic pressure is applied. The rotor is either fabricated as a separate disc which is bolted to a hub structure, or fabricated integrally with the hub structure; a brake drum is generally fabricated as a separate unit which is attached to the hub structure. Frictional engagement of the brake pads, for example to slow a vehicle, generates significant amounts of heat, which has several consequences. One of these is that the brake pads become heated, thus exposing the brake pads, hydraulic fluid, and the sundry elastomeric materials used in the hydraulic system to elevated temperatures while the brake is in use. These difficulties have been largely solved; brake hydraulic systems and pad materials resistant to temperatures in excess of 500° C. are available.

The rotor or drum has to dissipate the major proportion of the heat generated in braking, and at least the surfaces in frictional engagement with the pads can reach temperatures approaching 500° C. The rotor or drum also has to accommodate the braking forces and desirably should have sufficient wear resistance to have an extended working life. In addition, it has to be made from a material which can be machined accurately, particularly if the hub is formed integrally with the rotor. The commonest material currently used for disc brake rotors and brake drums is grey cast iron: it can be readily cast and machined, will withstand both the temperature and stress conditions which occur on braking, and provides an acceptable working life.

However, the use of grey cast iron as the material for the rotor or drum does have three significant disadvantages.

First, iron is a poor conductor of heat, with the result that even when ventilated rotors with carefully configured internal air passageways are used, or when a finned brake drum is used, the rotor or drum once heated cools slowly. This can result in so-called brake fade if the brakes are used repetitively.

Second, an iron rotor or drum is a relatively heavy component, which complicates vehicle design as it increases the unsprung weight for each vehicle wheel. This is of importance in fuel consumption, ride comfort, and green house gas emission, and in the construction of suspension systems in competition vehicles and in aircraft.

Third, the cast iron used has a high coefficient of thermal expansion and a low elastic modulus. This results in a requirement for frequent machining to maintain the inner and outer rotor braking surfaces both flat and parallel, or to maintain the inner surface of a drum concentric with the hub. This level of maintenance can be both time consuming and expensive as it requires both accurate machining and dismantling of a significant proportion of the vehicle to retrieve the brake drum or rotor for attention.

### DESCRIPTION OF THE PRIOR ART

In order to overcome these disadvantages, it has been proposed to fabricate brake rotors from light metals, including aluminium, and aluminum alloys. Although light metals have acceptable strength properties, and far higher thermal conductivity than iron, the light metals cannot be used alone.

First, the light metals have inadequate resistance to frictional abrasion, and thus cannot provide an adequate working life. To overcome this disadvantage, light metal composite materials have been proposed, which comprise a light metal matrix reinforced with a second material dispersed in the metal matrix. Typical reinforcing materials include silicon carbide, silicon oxide(silica),boron carbide, boron nitride, titanium diboride, titanium carbide and alumina. The elastic moduli of light metal matrix composites (such as an aluminum matrix reinforced with silicon carbide) are higher than the elastic modulus of cast iron and of unreinforced aluminum. In addition, the coefficients of thermal expansion of light metal matrix composites are lower than both cast iron and unreinforced aluminum. These composite materials do have superior wear resistance compared to grey cast iron components.

Second, even though light metal composites have far better thermal conductivity, adequate strength and wear resistant properties are only obtained if the brake rotor surface in service does not exceed a temperature of above about 400° C. If the rotor surface temperature exceeds this value, and for example rises to above about 500° C., the rotor will fail rapidly due to softening of the light metal matrix. Even commercially available aluminum composites reinforced with silicon carbide (such as Duralcan (trade mark) composites) have a compressive strength as low as about 50 MPa at about 450° C. This is no better than unreinforced aluminum alloys at that temperature. As a result, commercial light metal composite brake rotors are suitable for use only for relatively light vehicles under about 1,100 kg in weight and even then primarily for the less stressed rear brake rotors.

Takagi et al., in U.S. Pat. No. 5,514,480, describe a metal matrix hybrid material which is, in many ways, typical of the known light metal matrix composite materials. In Takagi et al. the aim is to diminish the frictional coefficient between the aluminium matrix and another metal surface; for example, the composite is stated to be useful in the manufacture of cylinders for aluminium based internal combustion engines. The composite material described by Takagi et al. contains aluminium, or an aluminium alloy, as the metal phase with three added components. These are alumina fibers and mullite particles which largely act as reinforcement and either nickel coated graphite or boron nitride cermet particles which Takagi et al describe as “solid lubricant particles”. With specific reference to the use of nickel coated graphite, Takagi et al. make two significant statements. First, as shown #15 in FIG. 3 and described at Col. 5, line 27ff, the nickel coating on the graphite particles survives into the finished composite material. Second, it is stated that the hardness of the metal matrix is only marginally increased in the composite material; the cited increase is given to be only 7% in comparison to the hardness of the alloy used. As is discussed more fully below, the investigation of the behaviour of metallic nickel under the conditions used by Takagi et al. to fabricate their composite materials has shown that these statements are largely correct. The nickel coating does indeed survive as described on the graphite particles.

### BRIEF DESCRIPTION OF THE DRAWINGS

The invention will now be described with reference to the attached drawings in which:

FIGS. 1(a), 1(b) and 1(c) show samples as-received nickel powder at differing levels of magnification;

FIGS. 2(a), 2(b) and 2(c) show samples of the nickel powder of FIG. 1 after heat treatment;

FIGS. 3(a) and 3(b) show samples of the nickel powder of FIG. 2 after investment with an aluminium matrix;

FIGS. 4(a) and (b) show samples of the nickel powder of FIG. 1 after investment with an aluminium matrix;

FIGS. 5(a), 5(b) and 5(c) show SEM and EDX profiles for the powder of FIG. 2 in a matrix of aluminium alloy A 356;

FIGS. 6(a), 6(b) and 6(c) show SEM and EDX profiles for the powder of FIG. 1 in a matrix of aluminium alloy A 356;

FIGS. 7-11 are optical micrographs showing the locations of Vickers scale hardness (Hᵥ) measurements on several composite materials.

### DESCRIPTION OF THE INVENTION

This invention seeks to overcome the disadvantages indicated above, and to provide a hybrid aluminum composite material which retains adequate strength and wear properties up to at least 450° C., and preferably up to at least about 500° C. In the hybrid aluminum composite material of this invention at least one further metallic material with different properties to the metal matrix is incorporated in an effective amount into the metal matrix in addition to at least one reinforcing material.

Thus in a first embodiment, this invention seeks to provide a hybrid aluminum, or aluminum alloy, metal composite comprising in combination a metal matrix having dispersed therein:

(a) from about 5% to about 45% by volume of at least one particulate, whisker or fibre reinforcement material chosen from the group consisting of alumina, silicon carbide, silicon dioxide, boron carbide, boron nitride, titanium diboride, and titanium carbide; and

(b) from about 1% to about 45% by volume of at least one intermetallic metal compound of aluminum with at least one second metal, in which the at least one second metal is chosen from at least one member of the group consisting of nickel, iron, titanium, cobalt, niobium and zirconium.

Preferably, the aluminum is an aluminum alloy, or a magnesium alloy containing a significant percentage of aluminum.

Preferably, the intermetallic compound is a binary intermetallic compound, and the second metal is nickel or iron.

Preferably, the intermetallic compound has a particle size range of from about 0.10 μm to about 100 μm.

Preferably, the light metal matrix contains from about 1% to about 45% by volume nickel or iron intermetallic compound.

Preferably, the reinforcement material is alumina or silicon carbide.

Preferably, the reinforcement material is particulate, and has a particle size range of from about 1 μm to about 50 μm.

Preferably, the composite contains from about 15% to about 40% by volume reinforcement. More preferably, the composite contains about 30% by volume reinforcement.

In a second broad embodiment this invention seeks to provide a process for the preparation of a metal composite comprising in combination an aluminum, or aluminum alloy, metal matrix having dispersed therein effective amounts of each of:

(a) a particulate, whisker or fibre reinforcement material chosen from the group consisting of alumina, silicon carbide, silicon dioxide, boron carbide, boron nitride, titanium diboride, and titanium carbide; and

(b) at least one intermetallic metal compound of aluminum with at least one second metal, in which the at least one second metal is chosen from the group consisting of nickel, iron, titanium, cobalt, niobium and zirconium;

which process comprises:

(i) fabricating a preform comprising the reinforcement;

(ii) placing the preform into a suitably shaped mould;

(iii) mixing an appropriate quantity of the at least one second metal in particulate or fiber form into a suitable amount of molten matrix metal under conditions which minimise any surface oxidation of the particulate or fiber form second metal;

(iv) investing the preform in the mould with the molten metal; and

(v) retrieving the reinforced metal composite casting from the mould.

Preferably, the preform is invested with molten light metal by the squeeze casting technique.

Preferably, the preform used in step (ii) is constructed and arranged to reinforce only a part of the metal composite, and is placed in the mould at the part to be reinforced.

Preferably, the second metal powder has a particle size range of from about 0.1 μm to about 50 μm.

The additional materials added to the metal matrix in the hybrid composites of this invention each serve different purposes.

The at least one intermetallic compound functions as a hardening agent for the metal matrix. Typical binary intermetallic compounds are: for nickel, NiAl, Ni₂Al₃ and Ni₃Al; for iron, FeAl and Fe₃Al; for titanium, TiAl, Ti₃Al, TiAl₂ and TiAl₃; for cobalt, CoAl; for zirconium, Zr₃Al; and for niobium, Nb₃Al. Depending on the elements present in the melt, particularly for an aluminium alloy, ternary intermetallic compounds can also be formed. Thus any element which will form an aluminide which has better mechanical strength and hardness than the matrix metal, both at room temperature and at an elevated temperature, preferably of at least about 400° C. can be used as the at least one second metal. The element will form an aluminide under two conditions: in an aluminium melt at a temperature of at least about 700° C., and it has a high enough activation energy that solid state diffusion will occur to form aluminide when the composite is subjected to a temperature in the range of from about 350° C. to about 500° C. To facilitate the hardening process, the at least one second metal is preferably added in a particulate form, with a particle size of from about 0.1 μm to about 100 μm. If desired, other particle sizes can be used.

The amount of the second metal incorporated into the metal matrix to ensure that hardening takes place is largely determined by two factors. The first is that with minimal experimentation it is possible to determine the level of hardness to be expected from a selected volume fraction of second metal. The second is that the practical limits appear to be at about 1 volume % and about 40 volume %. At an amount below about 1% there is little or no detectable improvement in the hardness of the composite material. At an amount above about 40% the properties of the aluminium-second metal intermetallic compound start to become more significant than those of the metal matrix, to the detriment of the desired properties of the light metal alloy composite material.

However, for the hardening to be obtained in a component fabricated from the metal matrix and the chosen second metal in particulate or fibrous form it is necessary to ensure that oxidation of the surface of the particles of the second metal be avoided as much as is reasonably possible. As is discussed below in more detail, if the surface of the second metal particles is allowed to acquire a significant coating of oxide in addition to the minimal, thin, layer generally present, for example an acquired coating of NiO on Ni, or of FeO or Fe₂O₃ on Fe, then the desired level of hardening is not likely to happen. It has been found that surface oxidation can be largely avoided if the powdered second metal is blended reasonably rapidly into the molten matrix metal, or if the second metal is not exposed to high temperatures prior its exposure to molten aluminium. Alternatively, a blanket of inert gas, for example nitrogen, can also be used to protect the second metal particles.

The hardening step depends upon surface reaction between the second metal and the aluminium in the investing metal matrix: in the presence of a significant coating of oxide on the particles of the second metal the hardening process is materially hindered, because the aluminium in the investing metal apparently cannot penetrate the oxide coating. The hardening process can only happen to the extent that either the oxide coating is not complete, or is sufficiently cracked, to allow the investing metal at least some access to a largely unoxidised second metal surface.

This feature of this invention, and its effect on the metal matrix composite materials described by Takagi et al. referenced above is best understood from a consideration of the drawings.

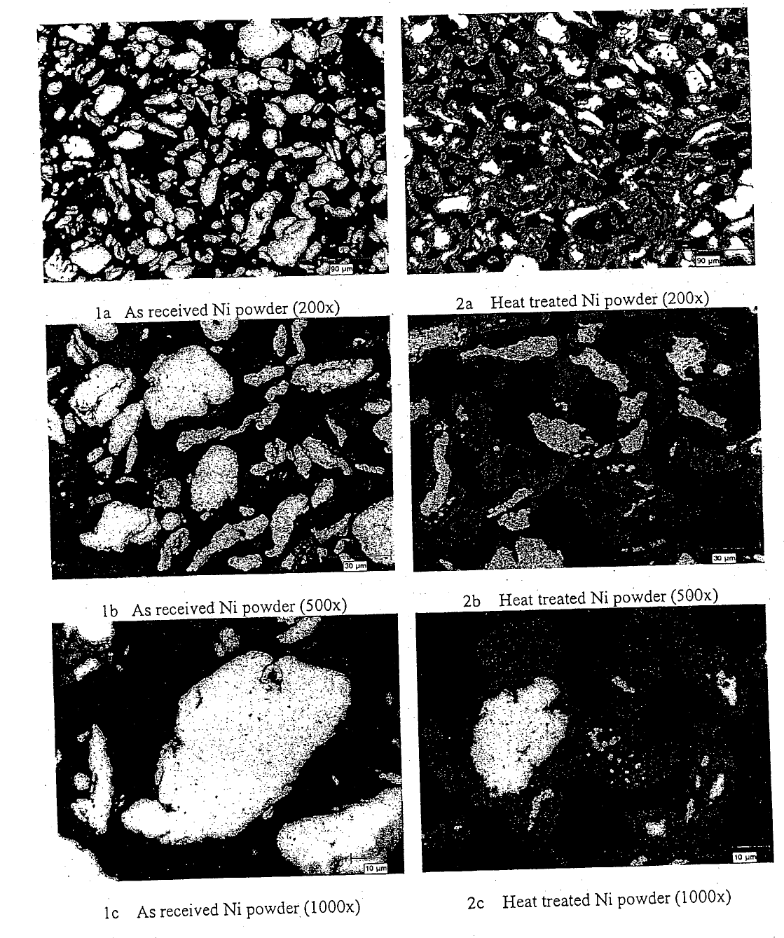

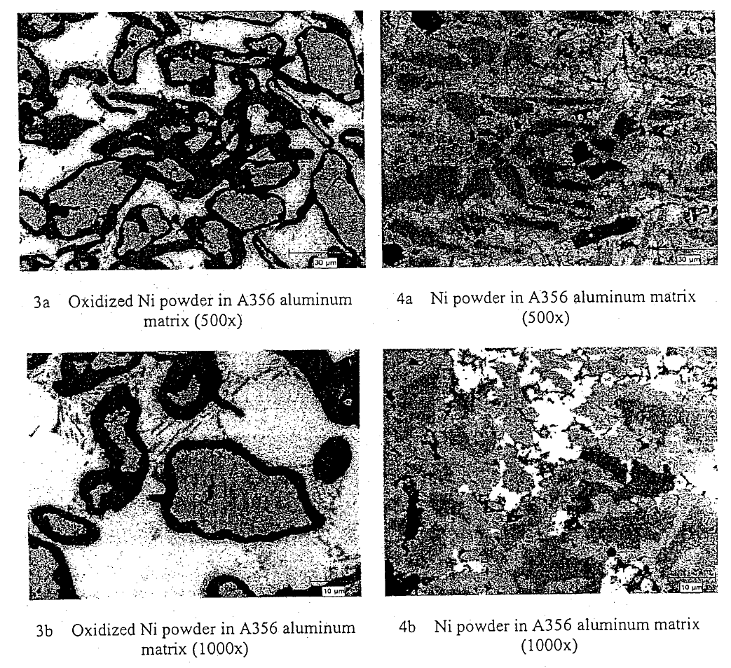

Referring first to FIGS. 1(a), 1(b) and 1(c), these show optical micrographs, at three different levels of magnification, of commercial nickel powder as received from the makers. While it is natural for the nickel particles to have a thin adherent oxide layer, this oxide layer generally is too thin to be observed by optical microscopy. This powder can also, for the purposes of these experiments, be taken to be equivalent to the nickel coated graphite used by Takagi et al. In FIGS. 1 and 2 the thin medium grey rim around the particles is nickel oxide, and the central light grey area is nickel.

In the process described by Takagi et al., the nickel coated graphite particles were subjected to 700° C. during the “formed mixture” preparation step. FIGS. 2(a), 2(b) and 2(c) show the same nickel powder as in FIG. 1 after being subjected to 700° C. as described by Takagi et al. These Figures each show a wide medium grey band of nickel oxide around the light grey nickel particles; comparison of FIGS. 1(c) and 2(c) shows that the smaller nickel particles have been oxidised completely.

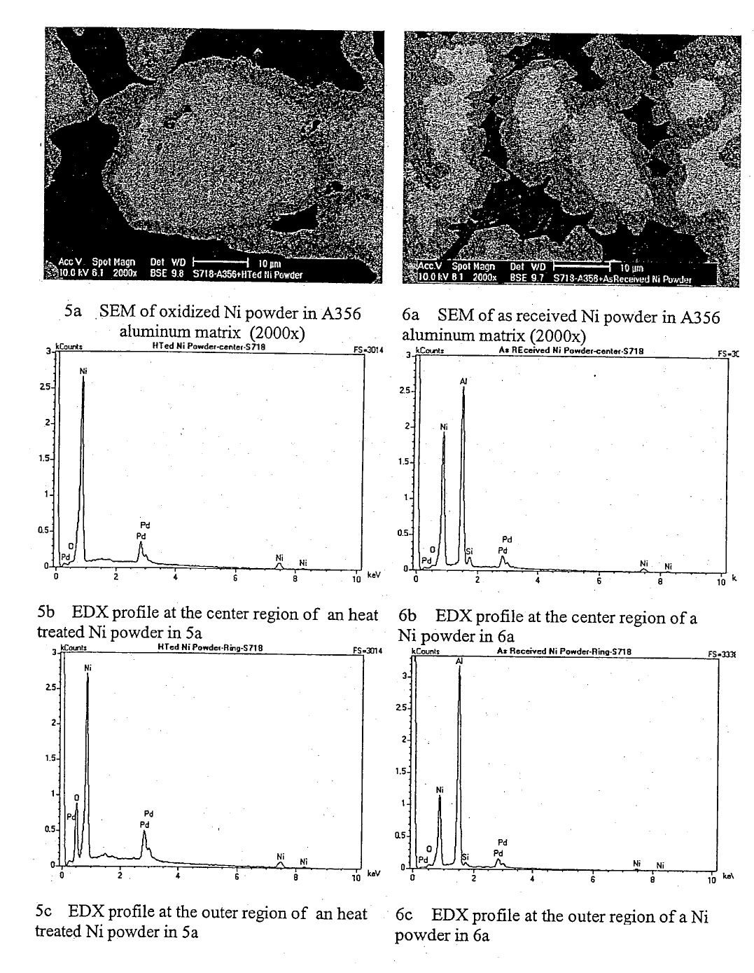

FIGS. 3 and 4 show what happens when the powders used in FIGS. 1 and 2 are each exposed to molten aluminium under the matrix investment conditions described by Takagi et al., using aluminium alloy A356 as the investment metal. In FIGS. 3 and 4 the lightest grey areas are the aluminium investment alloy; the black areas are nickel oxide, and the medium grey areas are nickel aluminide. In FIGS. 3(a) and 3(b) there is no visible interaction between the nickel particles and the alloy, whereas in FIGS. 4(a) and 4(b) there is visible extensive interaction of the nickel powder and the alloy, almost to the point of formation of a single phase.

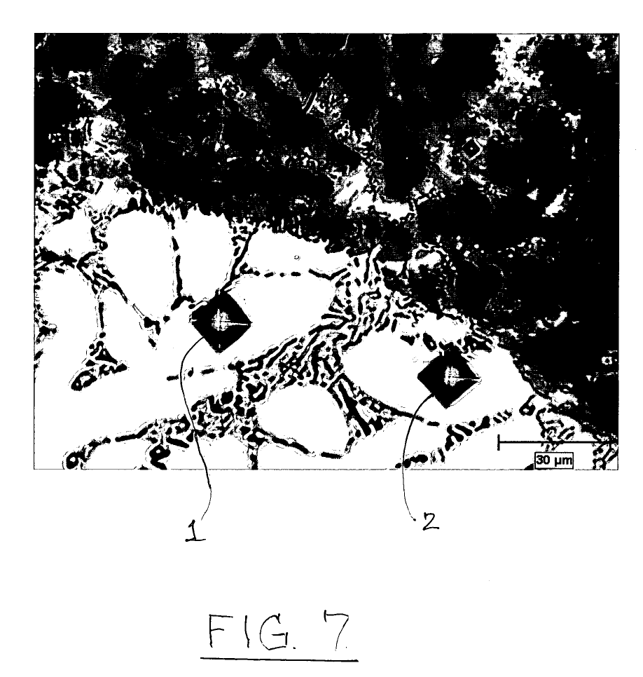

In order to confirm these visual observations, a scanning electron microscopy examination was carried out. The SEM results are shown in FIGS. 5(a) and 6(a) for the powders of FIGS. 1 and 2 respectively after investment with A356 aluminium alloy. By conducting Energy Dispersive X-ray analysis on the two types of powder in the aluminium matrix the data plotted in FIGS. 5(b) and 5(c), and in FIGS. 6(b) and 6(c) were obtained. In these four plots the palladium peak is not a component of either the nickel powder or the A356 investment alloy; it is due to the experimental preparation technique used. FIG. 5(b) was taken at the center of the large particle, and FIG. 5(c), was taken at the edge of the large particle. The only analysis peaks to be seen are for nickel (FIG. 5(b)) and nickel and oxygen (FIG. 5(c)). In direct contrast, FIGS. 6(b) and 6(c), again showing analysis at the center and edge of the particle respectively, both show a strong peak for aluminium as well as one for nickel.

This indicates quite strongly that if the nickel powder has an oxide film, the aluminium matrix metal does not penetrate it.

In order to confirm the formation of nickel-aluminium binary bimetallic compounds, the hardness of the nickel particles of FIGS. 1 and 2 invested with aluminium alloy A356 was also investigated.

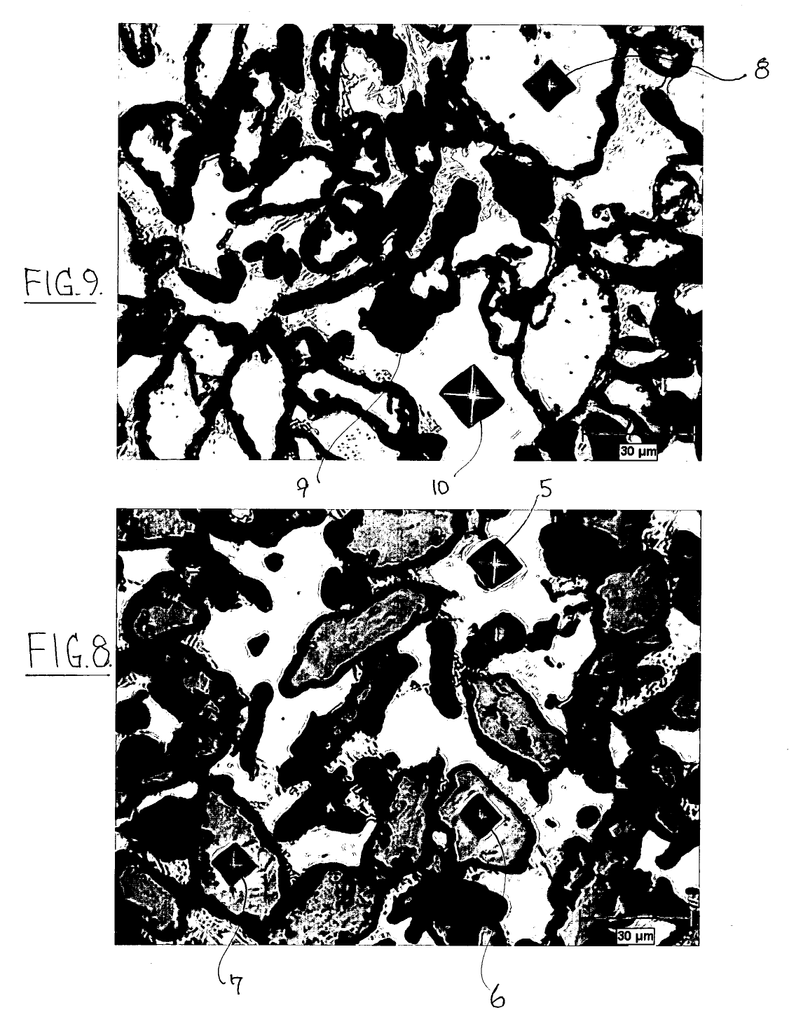

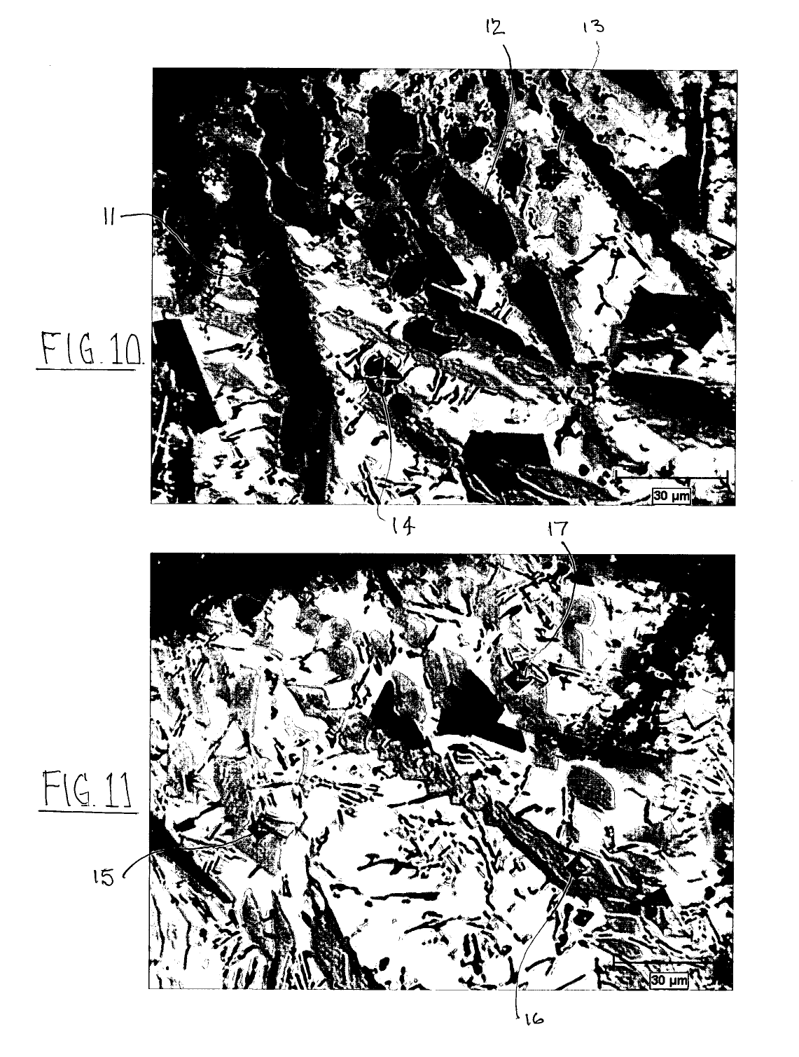

The micrographs in FIGS. 7-11 show the locations at which the hardness values were measured. The hardnesses were measured on the Vickers scale, Hᵥ, using the method set out in ASTM E 92-82, as re-approved in 1997. In FIGS. 7-11 the symbol [symbol] indicates the points at which Hᵥ readings were obtained. The hardness results are summarised in Table 1.

TABLE 1

| | Test | | | |
|---|---|---|---|---|
| Figure | No. | Ni Type | H_{V} | Phase Tested. |
| | 1 | | 69 | A356 alloy |
| | 2 | | 69 | A356 alloy |
| | 3 | | 350 | Al rich AlₓNi_{y} |
| | 4 | | 868 | Ni rich AlₓNi_{y} |
| | 5 | | 86 | A356 alloy |
| | 6 | | 134 | Nickel |
| | 7 | | 132 | Nickel |
| | 8 | | 92 | Nickel |
| | 9 | | 599 | Nickel Oxide |
| | 10 | | 58 | A356 alloy |
| | 11 | | 910 | Ni rich AlₓNi_{y} |
| | 12 | | 100 | Ni rich AlₓNi_{y} |
| | | | 1 | |
| | 13 | | 172 | Ni rich AlₓNi_{y} |
| | 14 | | 168 | Ni rich AlₓNi_{y} |
| | 15 | | 467 | Al rich AlₓNi_{y} |
| | 16 | | 556 | Al rich AlₓNi_{y} |
| | 17 | | 375 | Al rich AlₓNi_{y} |

In Table 1, “Ni Type” refers to as-received nickel powder as shown FIG. 1 and to oxidised powder as shown in FIG. 2 respectively. The phase assignments are based on the known hardnesses of the several materials, on the location of the test site, and on the analysis results in FIGS. 5(b), 5(c), 6(b) and 6(c).

Three conclusions follow from FIGS. 1-11.

First, under the conditions of the investment procedure used by Takagi et al. a significant surface coating of nickel oxide—probably NiO—is formed. It appears that Takagi. et al were not aware that this was occurring.

Second, that when such an oxide coating is present, minimal formation of aluminide can happen because the molten aluminium investment metal appears to be unable penetrate the nickel oxide coating on the nickel.

Third, the statements by Takagi et al. that the nickel coated graphite survives intact with its nickel coating, and that only a low level of hardening occurs in the metal matrix, are both correct: the oxide coating created on the nickel layer by the processing conditions both protects the graphite from being vaporised at the investment temperature, and also effectively prevents any significant level of aluminide formation, without which hardening cannot happen.

FIGS. 1-11 are also relevant to this invention. They show that it is important to organise the conditions under which the composite is to be made so that significant oxidation of the second metal is avoided. It has been found that this can be achieved by ensuring that the second metal, typically powdered nickel, is mixed reasonable quickly into the molten aluminium investing metal, or is protected from exposure to high temperatures prior to admixture with the molten investment metal. If desired, the second metal can also be protected by the use of an inert gas blanket, such as nitrogen. Techniques for creating and maintaining such an inert gas blanket are well known.

In making the metal matrix composite materials of this invention, the metal phase is commonly invested into the reinforcing materials in the form of a preform. These preforms are often bonded together by a silica based system; one method used in this invention for preform preparation is that described by Lo and Santos, in U.S. Pat. No. 6,193,915. In preparing the preform, a particulate reinforcement material is generally used, having a particle size of about 1 μm to about 50 μm. Particulate reinforcement materials within this size range have been found to be most effective. If desired, particles outside this size range an be used.

These preform preparation procedures commonly involve a firing step at a temperature in the neighbourhood of 1,000° C. The preform will often contain all of the materials to be added to the composite material. It then follows that for the hybrid composite materials of this invention when a preform is used which is fired at an elevated temperature it should not include the second metal. If it does, there will be a real and significant risk that most, if not all, of the second metal particles or fibres will acquire a coating of oxide which will severely, if not completely, obstruct the required hardening reaction. If there is any concern that such an oxide coating is being formed, for example if the properties of the product are not what they were expected to be, SEM and EDX analysis will disclose whether oxide formation has occurred.

It should also be noted that the pore size in a preform is of some importance. In preparing a preform, care needs to be taken to ensure that a substantial proportion, and preferably most of, the pores in the preform are large enough to allow the particles of the second metal to enter them in the molten matrix metal. This serves to promote optimal distribution of the second metal in the aluminium matrix. If the pore sizes in a preform are not adequately controlled, the preform to some extent will function as a filter thus preventing optimal distribution of the second metal particles in the investing metal matrix. This lack of optimal distribution can adversely affect the properties of the final product. It then also follows that there is some relationship between the shape and the size of the reinforcement particles. The data in Table 2 provides some guidance on this relationship.

TABLE 2

| Reinforcement | Vol % | Shape and Size |
|---|---|---|
| Not Ceramic | 5-45% | Whiskers: ˜1-10 μm |
| | | diameter |
| | | Particles: ˜5-50 μm |
| | | Fibers: ˜10 μm diameter |
| Ceramic | 14-45% | 5-50 μm |
| Particles | | |
| 2nd. Metal | 1-45% | 0.1-50 μm |
| Powder | | |

Although this invention is primarily concerned with the use of aluminium, or aluminium alloys, as the matrix metal, certain magnesium alloys also contain sufficiently high percentages of aluminium. These alloys can also be hardened by the formation of aluminides using the teachings of this invention.

When the metal composite is made according to the process of this invention, these intermetallic compounds are formed to some extent initially when the reinforcement and the other particulate materials are invested with molten light metal, for example in fabricating a hybrid metal composite body using the known squeeze casting process, by reaction of the at least one second metal with the molten aluminum or aluminum alloy. However, formation of the intermetallic compounds also occurs by a solid state diffusion process which is thermally activated. It has been found that formation of the intermetallic compounds proceeds further, each time the hybrid light metal composite body is put through a heating cycle to a sufficiently high temperature, for example the repeated heating and cooling cycles to which a brake rotor is exposed. Since the intermetallic compounds have the effect of hardening the light metal matrix, a body fabricated from the hybrid metal composite of this invention is both self hardening, and also continues to harden further during use when that use involves periodic heating of the body. It is thus apparent that the hybrid metal composite materials of this invention are particularly useful for brake components, especially disc brake rotors and brake drums, as these are subjected to heat cycling every time the vehicle brakes are used; strengthening of a rotor, for example, is thus an on-going process. Alternatively, if desired the hardening of a fabricated object can be increased before use by a suitable tempering procedure.

In the process aspect of this invention, the at least one second metal is added in a particulate or fiber form, and the casting and use conditions are then relied upon to both initiate and continue the solid state reaction to form the intermetallic compound.

It is also possible to add the at least one second metal as a binary aluminide intermetallic compound directly to the aluminum metal matrix during the mixing step in the casting process. This is not recommended, as it has three disadvantages.

First, the intermetallic compounds in powder form are significantly more expensive than the corresponding powdered second metals.

Second, since wetting of the intermetallic compound powder by the molten metal matrix may not be fully achieved during the fabrication process, it is possible that the interfacial strength between the intermetallic compound powder and the metal matrix may not be sufficient to add the desired level of strength to the metal composite. When the second metal is added as a powder or a fiber, a metallurgical bond is formed when the second metal powder reacts with the metal matrix to provide the intermetallic compound(s) in the metal matrix.

Third, the resulting reinforced metal matrix composite as cast will be effectively fully hardened, with the result that it is very difficult to finish machine to its final shape.

One objective of adding the at least one second metal as a powder or fiber is that during the squeeze casting process, for example to cast a brake rotor, the added metal powder only reacts partially with the molten aluminium to form the intermetallic compound, or compounds. Thus, the as-cast brake rotor containing only a limited amount of intermetallic compound, or compounds, can be readily machined to the required final dimensions. During service, the brake rotor under braking will be repeatedly heated. The repeated heat cycling of the rotor, especially under heavy and/or repeated braking which can involve brake rotor temperatures of in excess of 400° C., activates the reaction of the remaining at least one second metal with the aluminium matrix. As the amount of intermetallic compound, or compounds, present increases, so also does the high temperature strength of the brake rotor. If desired, in order to ensure adequate initial high temperature strength, a finished component can be thermally cycled up to a temperature of from at least about 300° C. to about 500° C. prior to use.

Since the total amount of the additives incorporated into the aluminum, or aluminum alloy, metal matrix composite bodies according to this invention can be quite low, the composite largely retains the ductility and machinability of the metal. The known properties of the matrix metal can therefore generally be used as the basic design parameters for the hybrid composite body. As noted above, if the volume fraction of the second metal is allowed to rise too far, then the properties of the matrix metal can be significantly compromised.

The metal used in this invention can be either aluminum, or an aluminum alloy. Many such alloys are commercially available, and recommended for use for both cast and wrought products; those for wrought products generally have better mechanical properties. Typical alloying elements include relatively low amounts of iron, copper, manganese, magnesium, chromium, nickel, zinc, gallium, vanadium, titanium, zirconium, lithium, tin, boron, cobalt, beryllium, bismuth and lead. Additionally, in certain magnesium alloys although the major metal is magnesium, the percentage of aluminium is high enough for aluminium intermetallic compounds to be formed. The properties of these magnesium alloys can be altered using the teachings of this invention.

What is claimed is:

1. A hybrid aluminum, or aluminum alloy, metal composite comprising in combination a metal matrix having dispersed therein:
(a) from about 5% to about 45% by volume of a particulate, whisker or fibre reinforcement material chosen from the group consisting of alumina, silicon carbide, silicon dioxide, boron carbide, boron nitride, titanium diboride, and titanium carbide; and
(b) from about 1% to about 40% by volume of at least one intermetallic metal compound of aluminum with at least one second metal, in which the at least one second metal is chosen from at least one member of the group consisting of nickel, iron, titanium, cobalt, niobium and zirconium.

2. A hybrid metal composite according to claim 1 wherein the at least one second metal is chosen from at least one member of the group consisting of nickel, iron and titanium.

3. A hybrid metal composite according to claim 1 wherein the at least one intermetallic compound has a particle size range of from about 1 μm to about 100 μm.

4. A hybrid metal composite according to claim 1 wherein the light metal matrix contains about 2% by volume binary metallic compound in which the second metal is chosen from the group consisting of nickel and iron.

5. A hybrid metal composite according to claim 1 wherein the particulate reinforcement material is alumina or silicon carbide.

6. A hybrid metal composite according to claim 1 wherein the reinforcement material is particulate, and has a particle size range of from about 1 μm to about 50 μm.

7. A hybrid metal composite according to claim 1 wherein the composite contains from about 15% to about 35% by volume reinforcement.

8. A hybrid metal composite according to claim 1 wherein the composite contains about 30% by volume reinforcement.

9. A process for the preparation of a metal composite comprising in combination an aluminum, or aluminum alloy, metal matrix having dispersed therein effective amounts of each of:
(a) a particulate, whisker or fibre reinforcement material chosen from the group consisting of alumina, silicon dioxide, boron carbide, silicon carbide, and titanium carbide; and
(b) at least one intermetallic metal compound of aluminum with at least one second metal, in which the second metal is chosen from at least one member of the group consisting of nickel, iron, titanium, cobalt, niobium and zirconium;
which process comprises:
(i) fabricating a preform comprising the reinforcement;
(ii) placing the preform into a suitably shaped mould;
(iii) mixing an appropriate quantity of the second metal in particulate or fiber form into a suitable amount of molten metal under conditions which minimise any surface oxidation of the particulate or fiber form second metal;
(iv) investing the preform in the mould with the molten metal; and
(v) retrieving the reinforced metal composite casting from the mould.

10. A process according to claim 9 wherein the preform is invested with molten light metal by the squeeze casting technique.

11. A process according to claim 9 wherein the second metal powder has a particle size range of from about 20 μm to about 50 μm.

12. A process according to claim 9 including the further steps of:
(vi) finish machining the casting to desired dimensions; and
(vii) thermally cycling the finished casting to a temperature of from at least about 300° C. to about 500° C. until a desired initial high temperature strength is obtained.

13. A process according to claim 9 wherein the preform used in step (ii) is constructed and arranged to reinforce only a part of the metal composite, and is placed in the mould at the part to be reinforced.
